(19) United States
(12) Patent Application Publication
(10) Pub. No.: US 2016/0011921 A1
(43) Pub. Date: Jan. 14, 2016

(54) CYBER SECURED AIRGAP REMOTE MONITORING AND DIAGNOSTICS INFRASTRUCTURE

(71) Applicant: GENERAL ELECTRIC COMPANY, Schenectady, NY (US)

(72) Inventors: Kotesh Kummamuri Rao, Pearland, TX (US); Matthew Thomas Krueger, Houston, TX (US)

(21) Appl. No.: 14/330,720

(22) Filed: Jul. 14, 2014

(51) Int. Cl. G06F 11/07; H04L 29/06

(52) U.S. Cl. CPC G06F 11/079; H04L 63/0428; G06F 11/0709

(57) ABSTRACT

A system and method for remotely monitoring and diagnosing a device is disclosed. Data related to the device is obtained at a first network. The obtained data is encrypted to generate an encrypted code at the first network. A copy of the encrypted code is obtained at a second network that is separated from the first network via a non-network medium such as an air gap. The copy of the encrypted code is decoded to obtain the data related to the device at the second network. The data is used at the second network to monitor and diagnose the device at the second network.

### BACKGROUND OF THE INVENTION

The subject matter disclosed herein relates to remote monitoring and diagnostics, and more specifically, to a system and method for transferring data between separate networks to enable remote monitoring and diagnostics.

In remote monitoring and diagnostics, a diagnostic center at a remote location is connected to a customer location via a network. The diagnostic center obtains data from the customer location over the network. The data is generally related to a device at the customer location, such as a turbine. Operators at the remote location receive and monitor the data in order to diagnose the condition or operation of the device. This arrangement provides customer service without intrusive on-site visits and/or scheduled maintenance shutdowns, etc. However, having a network connection between the customer location and the diagnostics center exposes the customer location to the possibility of viruses from the remote location and/or undesired access or hacking from malevolent individuals who have gained access to the remote location. Potential customers can be hesitant to enter into a remote monitoring and diagnostics arrangement that carries such risks.

### BRIEF DESCRIPTION OF THE INVENTION

According to one aspect of the invention, a method of remotely monitoring and diagnosing a device includes: obtaining data from the device at a first network; encrypting the data to generate an encrypted code at the first network; obtaining a copy of the encrypted code at a second network separated from the first network via a non-network medium; decoding the copy of the encrypted code to obtain a copy of the data at the second network; and monitoring and diagnosing the device at the second network using the copy of the data.

According to another aspect of the invention, a system for remotely monitoring and diagnosing a device includes: a first network coupled to the device and configured to obtain a measurement of a parameter of the device and generate an encrypted code from the obtained measurement; and a second network separate from the first network by a non-network medium and configured to obtain a copy of the encrypted code from the first network over a non-network medium, wherein the second network is configured to decode the copy of the encrypted code to monitor and diagnose the device.

According to yet another aspect of the invention, a system for securely monitoring and diagnosing of a device includes: an interface of a first network that generates a signal indicative of a measured value of a parameter of the device; and a detector of a second network, the detector separated from the interface by an air gap and configured to receive the signal from the interface over the air gap, wherein the second network is configured to monitor and diagnose the device using the signal received at the detector.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 shows a system for remote monitoring and diagnostics of a device 106 according to one embodiment of the present disclosure; and

FIG. 2 shows a flowchart illustrating a method of remote monitoring and diagnosis of a device.

The detailed description explains embodiments of the invention, together with advantages and features, by way of example with reference to the drawings.

### DETAILED DESCRIPTION OF THE INVENTION

The present disclosure provides a system and method of remote monitoring and diagnosis of a device at a customer location that inhibits or reduces security risks of a remote location from affecting the customer location, such as reducing the possibility of the customer location receiving viruses and/or hacking from the remote location. The system includes a first network at the customer location and a second network at the remote location that is separate from the first network. Data is transmitted from the first network to the second network via a non-network connection or non-network medium. In one embodiment, the non-network medium may be an optical medium such that data displayed at an interface of the first network is read by an optical scanner of the second network. In another embodiment, the non-network medium is an acoustic medium such that the data is transmitted by the first network as an acoustic signal and received at the second network using an acoustic receiver, such as a microphone. In various aspects, the non-network medium employs an air gap that separates or isolates the first network from the second network so that data is not transmittable from the second network to the first network and the first network, thereby protecting the first network from security risks of the second network.

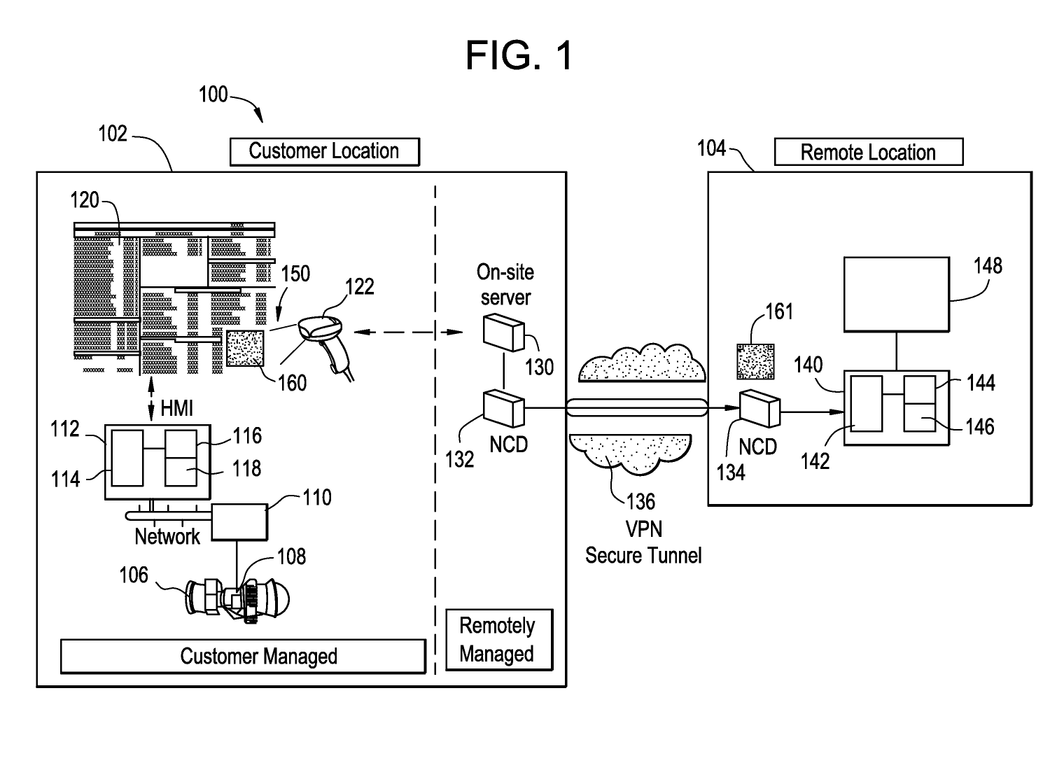

FIG. 1 shows a system 100 for remote monitoring and diagnostics of a device 106 according to one embodiment of the present disclosure. The system 100 includes a customer location 102 that includes the device 106 and a remote location 104 that provides various diagnostics services based on measurements obtained with respect to the device 106. In one embodiment, the device 106 is a turbine for providing energy or power. A sensor 108 disposed on the device 106 measures a value of a parameter of the device 106, such as air pressure, temperature, etc. The sensor 108 is coupled via a local network 110 to a control unit 112 which may be a server, mainframe computer, desktop computer, laptop computer, tablet, etc. The sensor 108 provides the measured values of the parameter of the device 106 to the control unit 112 over the local network 110. The control unit 112 can include a processor 114 and a memory storage device 116 that includes programs 118 stored therein. In various embodiments, the memory storage device 116 includes a non-transitory storage device, such as a solid-state memory device or RAM. The processor 114 receives the measured values of the parameter from the sensor 108 and encrypts the measured values to generate an encrypted code 160. Programs 118 can provide instructions to the processor 114 for encrypting the measured values. In one embodiment, the processor 114 can store the measured values of the parameter and/or the encrypted code 160 at the memory storage device 116. Alternatively, the processor 114 can display the measured values and/or the encrypted code 160 at a human-machine interface (“interface”) 120 as a visual signal. In various embodiments, the encrypted code 160 is displayed as a two-dimensional visual code, such as a QR code known in the art.

While the invention is described with respect to a single sensor 108, it is to be understood that a plurality of sensors may be used to measure values of various parameters of the device 106. In addition, the processor 114 can use some or all of the measured values from the plurality of sensors when generating the encrypted code 160.

In various embodiments, the sensor 108 measures the values of the parameter and sends the measured values to the processor 114 at a selected sampling rate (e.g., every 5 seconds). The sampling rate may be controlled or selected by the processor 114. When the values are received, the processor 114 generates the encrypted code 160 from the value and displays the encrypted code 160 at the interface 120. Thus, the encrypted code is generated dynamically at the interface 120 and is refreshed or replaced at the interface 120 at a selected time interval (refresh rate) that can correspond to the sampling rate (e.g., every 5 seconds).

The customer location 102 further includes a detector 122. The detector 122 can be coupled to a diagnostic unit 140 at the remote location 104. The detector 122 reads the encrypted code 160 from the interface 120 to obtain a copy 161 of the encrypted code 160. The detector 122 then sends the copy 161 of the encrypted code 160 to the diagnostic unit 140 at the remote location 104.

The detector 122 can be connected to the remote location 104 via a continuous network connection or a non-continuous network connection. In an embodiment with a continuous network connection, the detector 122 can be coupled to an on-site server 130 that can be remotely managed from the remote location 104. The on-site server 130 is further coupled to a network connectivity device 132 at the customer location 102 that communicates with a network connectivity device 134 at the remote location 104 over a network connection 136. In an embodiment with a non-continuous network connection, the detector 122 can store the encrypted code 160 at a memory location within the detector 122. The detector 122 can then be retrieved to the remote location 104 and plugged into the remote location 104 for downloading of the encrypted code 160 from the detector 122. In another embodiment of a non-continuous network, the detector 122 or the remote location 104 can initiate a temporary communication channel and transfer the encrypted code 160 from the detector 122 to the remote location 104 over the temporary communication channel

In one embodiment, the encrypted code 160 is read from the interface 120 and into the detector 122 over an optical medium. In this embodiment, the encrypted code 160 is displayed visually at the interface 120, and the detector 122 is an optical scanner that reads the visually-displayed code. The encrypted code 160 can be displayed at a designated location of the interface 120 such as a lower right corner of the interface 120 as shown in FIG. 1. The optical scanner may be placed in front of the interface 120 and directed at the encrypted code 160. The optical scanner may be programmed so as to read the encrypted code 160 at a given sampling rate corresponds to the refresh rate of the encrypted code 160 at the interface 120. In another embodiment, the encrypted code 160 is generated as an acoustic signal at the interface 120 or at a speaker of the interface 120 and the detector 122 is an acoustic receiver, such as a microphone, etc. In this embodiment, an acoustic medium is used to transfer the encrypted code 160 from the interface 120 to the detector 122. Therefore, the detector 122 can be an optical scanner or a microphone, depending on the selected medium. Additionally, the detector 122 can be a smartphone or a tablet computer or other device suitable for reading data over the selected medium.

In various embodiments, the interface 120 and detector 122 are separated by an air gap or other non-network medium 150 that separates and/or isolates a first network of the customer location 102 from a second network of the remote location 104. Additionally, the interface 120 and detector 122 provide communication in only one direction across the air gap, i.e., from the customer location 102 to the remote location 104. Thus, the remote location 104 can receive measurements or data from the customer location 102 that may be used for diagnostics of the device 106 at the customer location 102, without providing access from the remote location 104 to the customer location 102. The non-network medium 150 isolates the local network 110 and control unit 112 of the customer location 102 from the remote location 104. Therefore, the customer location 102 avoids being susceptible to security risks at the remote location 104, such as the risk of receiving viruses or other undesired access from the remote location 104.

The remote location includes a diagnostic unit 140 that includes a processor 142, memory storage device 144 and programs 146. In one embodiment, the processor 142 of the diagnostic unit 140 uses the programs 146 to perform a decoding operation to decode the copy 161 of the encrypted code 160, thereby obtaining the measured values of the parameter of the device 106 at the remote location 104. The processor 114 at the remote location 104 can then diagnose the device 106 using the obtained measured values of the parameter. The measured values of the parameter or diagnostics performed on the measured values can be shown at display 148 or stored to the memory storage device 144. In various embodiments, the memory storage device 144 includes a non-transitory storage device, such as a solid-state memory or RAM.

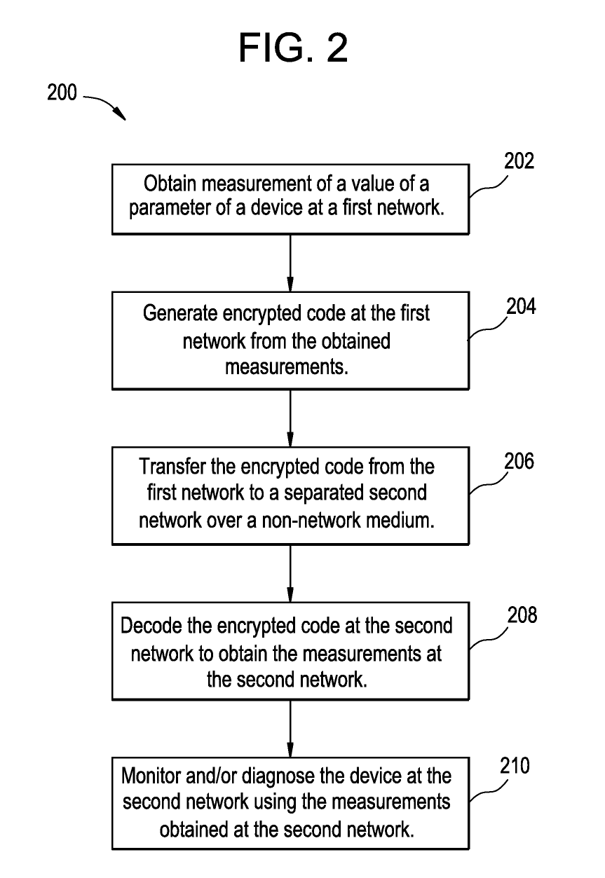

FIG. 2 shows a flowchart 200 illustrating a method of remote monitoring and diagnosis of a device. In block 202, data is obtained from a sensor that is coupled to the device. The sensor is coupled to a first network. In block 204, the data is encrypted to generate an encrypted code at an interface of the first network. In block 206, a detector of the second network is used to read the encrypted code from the interface. The data is therefore transferred from the first network to the second network without the use of a network connection or, in other words, over a non-network medium such as an air gap. In block 208, the encrypted code is decoded at the second network. Finally in block 210, the decoded data is used at the second network to diagnose the device.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of remotely monitoring and diagnosing a device, comprising:
obtaining data from the device at a first network;
encrypting the data to generate an encrypted code at the first network;
obtaining a copy of the encrypted code at a second network separated from the first network via a non-network medium;
decoding the copy of the encrypted code to obtain a copy of the data at the second network; and
monitoring and diagnosing the device at the second network using the copy of the data.

2. The method of claim 1, further comprising displaying the encrypted code as a visual signal at a visual interface of the first network and reading the visual signal from the visual interface via an optical scanner of the second network.

3. The method of claim 2, wherein the visual signal is a QR code.

4. The method of claim 1, further comprising generating an audio signal relating to the encrypted code at an audio transmitter of the first network and receiving the audio signal at an audio receiver of the second network.

5. The method of claim 1, wherein the first network is a private network.

6. The method of claim 1, further comprising generating the encrypted code dynamically at a selected refresh rate.

7. The method of claim 1, further comprising obtaining the copy of the data using at least one of: (i) a device having a continuous network connection to the second network; (ii) a device having a non-continuous connection to the second network; (iii) a tablet; (iv) a smartphone; (v) an optical scanner; (vi) an acoustic receiver; and (vi) a hand-held device.

8. A system for remotely monitoring and diagnosing a device, comprising:
a first network coupled to the device and configured to obtain a measurement of a parameter of the device and generate an encrypted code from the obtained measurement; and
a second network separate from the first network by a non-network medium and configured to obtain a copy of the encrypted code from the first network over a non-network medium, wherein the second network is configured to decode the copy of the encrypted code to monitor and diagnose the device.

9. The system of claim 8, wherein the first network further comprises an interface that visually displays the encrypted code and the second network further comprises a detector configured to obtain an image copy of the encrypted code.

10. The system of claim 9, wherein the encrypted code further comprises a QR code.

11. The system of claim 8, wherein the first network further comprises an audio generator configured to generate an audio signal corresponding to the encrypted code and the second network further comprises an audio receiver configured to receive the audio signal generated at the audio generator.

12. The system of claim 8, wherein the first network is a private network.

13. The system of claim 8, further comprising wherein the encrypted code is generated dynamically at a selected refresh rate.

14. The system of claim 8, wherein the detector further comprises at least one of: (i) a detector having a continuous network connection to the second network;
(ii) a detector having a non-continuous network connection to the second network;
(iii) a tablet; (iv) a smartphone; (v) an optical scanner; (vi) an audio receiver; and (vi) a hand-held device.

15. A system for securely monitoring and diagnosing of a device, comprising:
an interface of a first network that generates a signal indicative of a measured value of a parameter of the device; and
a detector of a second network, the detector separated from the interface by an air gap and configured to receive the signal from the interface over the air gap, wherein the second network is configured to monitor and diagnose the device using the signal received at the detector.

16. The system of claim 15, wherein the signal further comprises a visual signal displayed at the interface as an encrypted code and the detector receives an image of the encrypted code.

17. The system of claim 16, wherein the encrypted code further comprises a QR code.

18. The system of claim 16, wherein the signal further comprises an audio signal generated at the interface and the detector further comprises an audio receiver configured to receive the audio signal.

19. The system of claim 15, wherein the detector further comprises at least one of: (i) a detector having a continuous network connection to the second network;
(ii) a detector having a non-continuous network connection to the second network;
(iii) a tablet; (iv) a smartphone; (v) an optical scanner; (vi) an audio receiver; and (vi) a hand-held device.

20. The system of claim 15, wherein the signal is generated dynamically at the interface at a selected refresh rate.
